(19) United States
(12) Patent Application Publication
(10) Pub. No.: US 2026/0241386 A1
(43) Pub. Date: Aug. 20, 2026

(54) A VIAL CARRIER ASSEMBLY

(71) Applicant: Micromass UK Limited, Wilmslow (GB)

(72) Inventors: Leanne DAVEY, Wellingtonbridge (IE); Matthew WHERRY, Chapel-en-le-Frith (GB)

(21) Appl. No.: 19/160,685

(22) PCT Filed: Mar. 11, 2024
(86) PCT No.: PCT/GB2024/050651

§ 371 Date: Aug. 28, 2025

(30) Foreign Application Priority Data
Mar. 10, 2023 (GB) 2303592.6

(51) Int. Cl. B01L 9/06

(52) U.S. Cl. CPC B01L 9/06; B01L 2200/025; B01L 2300/021; B01L 2300/0829; B01L 2300/0858

(57) ABSTRACT

A vial carrier assembly comprising: a base having an opening, the opening having a width and a length; and a holder comprising a least one row of wells, the at least one row of wells of the holder being sized so as to be receivable into the opening across the width of the opening but not receivable into the opening across the length of the opening.

### FIELD

The present invention relates to a vial carrier assembly a vial carrier assembly handling system.

### BACKGROUND

Vial carriers in the form of well plates are known, comprising a plurality of wells arranged in a grid array. Each well may have substantially the same volume and be configured to receive a vial therein. A liquid may be received in the vial. In an alternative arrangement, a liquid may be received directly in the well. Substances other than liquids may be received in the vial and/or well.

A standard well plate (microplate) is “96-well plate”, which comprises 96 wells arranged in 12 columns and 8 rows. The wells on the plate are typically marked, or otherwise designated, to denote the columns by number (1-12) and the rows by letter (A-H).

The outer dimensions of well plates are normally standardised across suppliers, adopting the dimensions set by ANSI-/SLAS-Standards 1 to 4—2004.

A standard 96-well plate has a length of 127.76 mm, a width of 85.4 mm and a height of 14.35 mm.

The distance between the left outside edge of the plate and the center of the first column of wells is 14.38 mm. The distance between the top outside edge of the plate and the center of the first row of wells is 11.24 mm.

The ANSI standard requires that the top left well, having the co-ordinates A1, shall be marked in a distinguishing manner. This is so that the orientation of the well-plate can be visually determined, and a datum point established.

Providing well plates with standard dimensions allows for automatic handling of the well plates, using a liquid handler. A well plate is positioned at a known location relative to the liquid handler (for example using the datum point), and liquids can then be added to, removed from, or otherwise processed in the wells.

Other well plate sizes are possible, including 384-well (16 rows, 24 columns), 1536-well (32 rows, 48 columns). Any other well combination is possible, comprised of X rows and Y columns.

Well plates must be handled prior to, during or after a process. At least some of the wells of a well plate may be populated with a plurality of liquids from a plurality of sources. For example, one or more wells may be designated to receive a sample, calibrant, solvent and/or reagent. The liquids populated into the vials/wells may be formed by reconstituting a lyophilised substance in water.

Each liquid to be added to a well may have different handling and/or storage requirements. The storage requirements for the contents of one well may not be suitable for the contents of another well. For example, one liquid may need to be stored at below 0 c, which could adversely affect a liquid in another well if present. This may present difficulties in populating, handling and storing a well plate, such that liquids are only added in a predetermined order. For some processes, only some of the wells may be populated with liquid, leaving other wells redundant.

Thermo Fisher Scientific Inc manufactures a vial carrier assembly under the brand name ‘Piko’, comprising a base and a plurality of welled holders arrangeable in an opening in the base. A user may insert the holders in any position within the opening.

A problem with the known arrangement is that a user may insert a holder in any number of locations and/or a holder may be dislodged/moved in use before or during handling. Consequently, the location of a given vial or substance in a well may not be reliably determined or maintained. If such an arrangement is loaded into a liquid handler, a mislocated vial and/or holder may prevent the liquid handler from operating correctly, and/or cause damage to the liquid handler, holder and/or vials.

There is a desire to provide an improved vial carrier assembly.

### BRIEF DESCRIPTION OF THE INVENTION

The present invention provides a vial carrier assembly comprising:
a base having an opening, the opening having a width and a length; and
a holder comprising a least one row of wells, the at least one row of wells of the holder being sized so as to be receivable into the opening across the width of the opening but not receivable into the opening across the length of the opening.

The present invention provides a vial carrier assembly comprising:
a base having an opening, the base having a width and a length and the opening having a width and a length; and
a holder comprising a least one row of wells, the at least one row of wells of the holder being sized so as to be receivable into the opening across the width of the opening, wherein the length of the base is larger than the width of the base and the length of the opening is smaller than the width of the opening.

The present invention provides a vial carrier assembly comprising:
a base having an opening, the opening having a width and a length; and
a holder comprising a least one row of wells, the at least one row of wells of the holder being sized so as to be receivable into the opening across the width of the opening at a single predetermined location in a predetermined orientation.

In at least one embodiment, the holder comprises a plurality of rows of wells arranged parallel to one another to form an array of wells.

In at least one embodiment, the number of rows of wells is less than the number of wells in each row.

In at least one embodiment, the base comprises a top surface and the opening is provided on the top surface.

In at least one embodiment, the opening is asymmetrically positioned on the top surface.

In at least one embodiment, the base comprises a front wall, a back wall and two side walls.

In at least one embodiment, the opening is positioned closer to the front wall than to the back wall.

In at least one embodiment, the opening is positioned substantially equidistantly from the two side walls.

In at least one embodiment, the holder comprises a skirt, configured such that when the at least one row of wells is received in the opening, the skirt of the holder is positioned outside of the base.

In at least one embodiment, the skirt extends from the holder in a direction substantially parallel to the axes of the wells.

In at least one embodiment, the base comprises at least one base label, and the skirt is configured to at least partially conceal the or a base label when the at least one row of wells is received in the opening.

In at least one embodiment, the opening is provided with at least one locating feature, and the holder is provided with at least one complementary locating feature.

In at least one embodiment, the holder is selectively retainable in or on the base.

In at least one embodiment, the holder comprises at least two holder modules, each comprising at least one row of wells, the at least two holder modules being arrangeable together to define the holder.

In at least one embodiment, the base has a width of 85.5 cm and a length of 127.8 cm.

In at least one embodiment, the holder has a width of 82 cm.

In at least one embodiment, the holder has a length between 30 cm and 77 cm.

The present invention provides a vial carrier assembly handling system comprising:
a least one reader, configured to read at least one label on a base and/or holder of a vial carrier assembly arranged in readable range of the at least one reader;
a controller operatively connected to the at least one reader, the handling system configured to:
receive a command to verify the presence of a holder of the vial carrier assembly;
   read a label arranged in readable range of the at least one reader; and
   determine if the label is associated with a base or a holder, whereby:
   if the label is associated with a base, return an error; and
   if the label is associated with a holder, send a verification signal to indicate the presence of a holder.

### BRIEF DESCRIPTION OF THE FIGURES

In order that the present disclosure may be more readily understood, preferable embodiments thereof will now be described, by way of example only, with reference to the accompanying drawings, in which:

FIG. 1A illustrates a top view of a base of a vial carrier assembly embodying the invention;

FIG. 1B illustrates a perspective view of a base of a vial carrier assembly embodying the invention;

FIG. 1C illustrates a side view of a base of a vial carrier assembly embodying the invention;

FIG. 1D illustrates a front view of a base of a vial carrier assembly embodying the invention;

FIG. 2A illustrates a top view of a holder of a vial carrier assembly embodying the invention;

FIG. 2B illustrates a perspective view of a holder of a vial carrier assembly embodying the invention;

FIG. 2C illustrates a side view of a holder of a vial carrier assembly embodying the invention;

FIG. 2D illustrates a front view of a holder of a vial carrier assembly embodying the invention;

FIG. 3A illustrates a top view of another holder of a vial carrier assembly embodying the invention;

FIG. 3B illustrates a perspective view of another holder of a vial carrier assembly embodying the invention;

FIG. 3C illustrates a side view of another holder of a vial carrier assembly embodying the invention;

FIG. 3D illustrates a front view of another holder of a vial carrier assembly embodying the invention;

FIG. 4A illustrates a perspective view of vial carrier assembly embodying the invention, comprising the base illustrated in FIGS. 1A to 1D with the holder illustrated in FIGS. 2A to 2D;

FIG. 4B illustrates a perspective view of vial carrier assembly embodying the invention, comprising the base illustrated in FIGS. 1A to 1D with the holder illustrated in FIGS. 3A to 3D; and

FIG. 5 schematically illustrates a vial carrier assembly handling system embodying the present invention.

### DETAILED DESCRIPTION OF THE DISCLOSURE

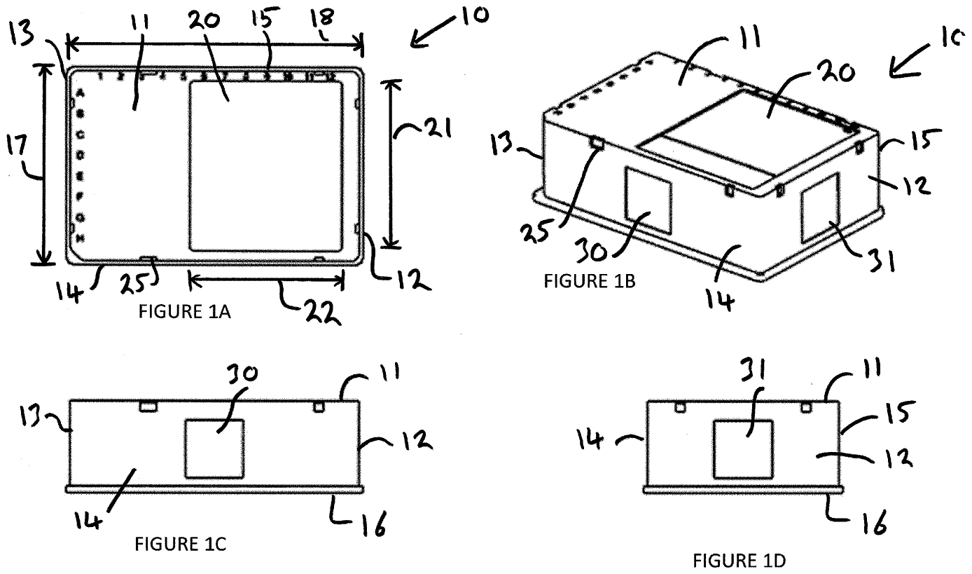

FIGS. 1A to 1D illustrate a base 10 of a vial carrier assembly 1 embodying the present invention. The base 10 comprises a top wall defining a top surface 11, a front wall 12, a back wall 13, and two side walls 14, 15. The front 12, back 13 and side 14, 15 walls are arranged substantially vertically in use, and are respectively perpendicular to the plane of the top surface 11. In use, the top surface 11 is arranged substantially horizontally.

The base 10 may further comprise a bottom 16. In the embodiment illustrated in FIGS. 1A to 1D, the bottom 16 of the base 10 is substantially open, and effectively defined by the bottom edges of the front 12, back 13 and side 14, 15 walls. The lower edges of the front 12, back 13 and side 14, 15 walls may be provided with a rim 19, as illustrated in FIGS. 1B to 1D. The rim 19 is not essential. The rim 19 may provide additional rigidity to the base 10. The base 10 is substantially cuboid in shape.

The base 10 has a width 17 and a length 18, as illustrated in FIG. 1A. The base width 17 is the width of the base 10 at its widest point. In the embodiment shown in FIG. 1A, the base width 17 is the distance from one edge of the rim 19 on a first side wall 14 to the edge of the rim 19 on the second side wall 15.

Similarly, the base length 18 is the longest distance between the ends of the base 10. In the embodiment shown in FIG. 1A, the base length 18 is the distance from the edge of the rim 19 on the front wall 12 to the edge of the rim 19 on the back wall 13.

In an embodiment without a rim 19, the base width would be the distance between the outer surface of the side walls 14, 15 and the base length would be the distance between the outer surface of the front wall 12 and back wall 13.

The base 10 further comprises an opening 20. In the embodiment illustrated, the opening 20 is provided in the top surface 11 of the base 10. The opening 20 is a through opening into the top wall so as to allow access into the inner volume of the base 10. In the isometric illustration of FIG. 1B, at least a part of the rear surface of the side wall 15 and at least part of the lower edge of the side wall 15 can be seen through the opening 20.

The height of the opening 20 is equal to the thickness of the top wall defining the top surface 11. The thickness of the top wall may be substantially the same as the thickness of the front 12, back 13 and side walls 14, 15. At least one additional strengthening rib may be provided to provide additional structural integrity to the base 10.

The opening 20 has an opening width 21, as illustrated in FIG. 1A. The opening width 21 is the distance between the edge of the opening adjacent one side wall 14 of the base and the opposite edge of the opening adjacent the other side wall 15. Likewise, the opening length 22 is the distance between the edge of the opening adjacent the front wall 12 and the opposite edge of the opening 20.

With reference to FIGS. 1A and 1B, it will be noted that the opening 20 is asymmetrically positioned on the top surface 11 relative to the length of the base 10. With reference to FIG. 1A, that is to say that the distance from the back wall 13 to the closest edge of the opening 20 is greater than the distance between the front wall 12 of the base 10 and the closest edge of the opening 20. This arrangement advantageously allows for a holder 50, 150, of a vial carrier assembly 1 embodying the present invention to be inserted into the opening 20 in a predetermined location and/or orientation.

With further reference to FIGS. 1A and 1B, it will be noted that the opening 20 is positioned substantially equidistantly from the two side walls. That is to say that the distance from the side wall 14 to closest edge of the opening 20 is substantially the same as the distance from the side wall 15 to the closest edge of the opening 20.

The base 10 may further comprise at least one base label 30, 31. In the embodiment shown in FIG. 1B, a first base label 30 is provided on a side wall 14 of the base 10, and a second base label 31 is provided on the front wall 12 of the base 10. The base labels 30, 31 may be identical to one another or substantially different. The base labels 30, 31 may be provided with various data, including a unique identifier (e.g. serial number) for the base 10, the type of base, the dimensions of the base 10, details of the datum point, and/or any other information of use to a liquid handler to correctly process the base. The base label 30, 31 may be a visual label, in which some or all information may be encoded in the form of a barcode, QR code, or GS1 data matrix. Information regarding the base 10 may otherwise be stored remotely, and can be interrogated and read by identifying a unique identifier in the base label 30, 31. Alternatively or additionally, the base label 30, 31 may take the form of a RFID tag, in which data are stored on the tag to be interrogated by an appropriate reader.

As illustrated in FIGS. 1A to 1D, the base 10 may further be provided with at least one locating feature 25. In the embodiment shown in FIG. 1B, there are six locating features 25. These are to receive corresponding locating features 57, 157 provided on a holder, 50, 150.

As illustrated in FIG. 1A, the top surface 11 may be provided with various indicia. In the embodiment shown, the edge of the top surface 11 adjacent the side wall 15 comprises markings denoting 1 to 15, and the edge of the top surface 11 adjacent the back wall 13 is provided with markings denoting the letters A to H.

In at least one embodiment, the base width may be 85.5 cm and the base length may be 127.8 cm. Overall, it is to be appreciated that the base 10 has an opening 20, and the opening has an opening width 21 and an opening length 22. For the avoidance of doubt, the base width 17 is measured in a direction parallel to the opening width 21. Likewise, the base length 18 is measured in a direction parallel to the opening length 22.

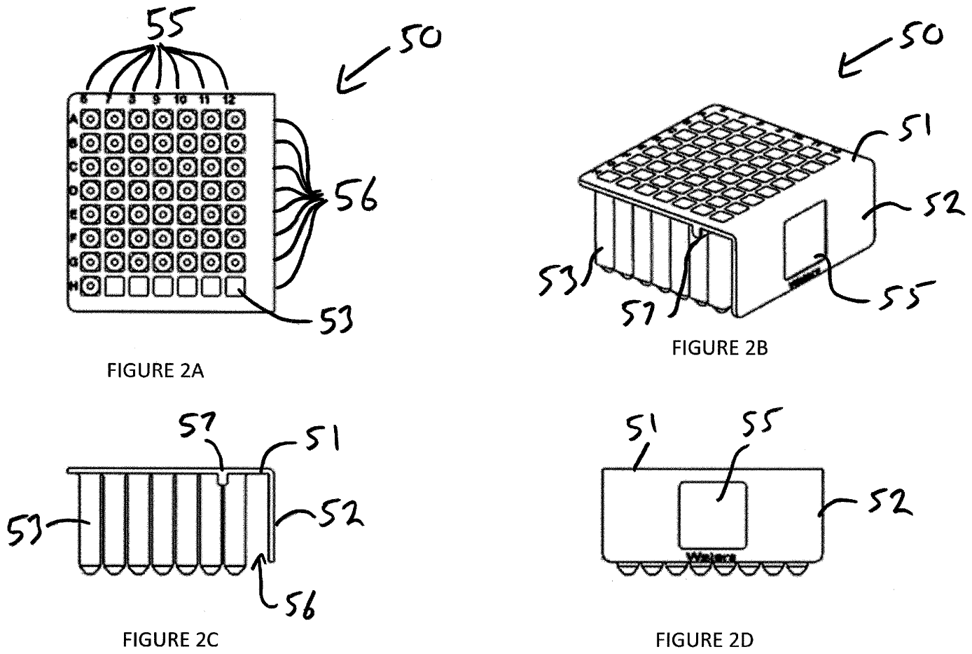

FIGS. 2A to 2D illustrate one embodiment of a holder 50 of a vial carrier assembly embodying the present invention. The holder 50 comprises a top wall having a surface 51 and a skirt 52. The skirt 52 extends substantially perpendicularly away from the top surface 51.

The holder 50 comprises a plurality of wells 53. The wells 53 are arranged in rows 55 and columns 56, in an array. The wells 53 within a row 55 may have substantially the same spacing (pitch) and the wells 53 within a column 56 may have substantially the same spacing (pitch). The wells 53 are arranged substantially parallel to one another such that the longitudinal axis of one well 53 is substantially parallel to the respective longitudinal axis of all other wells 53. In the embodiment shown, the holder 50 comprises seven rows 55 and eight columns 56. The rows 55 are labelled 6 to 12, and the columns 56 are labelled A to H. When the holder 50 is received in the opening 20 of the base 10, the indicia indicating the row numbers on the holder 50 will align with the corresponding indicia on the top surface 11 of the base 10.

One or more of the wells 53 may receive a vial, for example a glass or plastic vial. The vial may receive a liquid therein. Alternatively, a liquid may be received directly into the well 53, with the well effectively defining a vial. The use of the term ‘vial carrier assembly’ is intended to refer to both uses. As indicated in FIG. 2A, not all of the wells 53 may be populated with a vial and/or liquid. Some wells 53 may be left unoccupied, like the six wells H7 to H12 shown in FIG. 2A. At least some wells may be blanked off, so as not to be able to receive any vial/liquid therein. Accordingly, while the wells 53 may be arranged in an X×Y array, the total number of wells 53 may not be equal to the product of X and Y.

Although in the embodiment shown in FIGS. 2A to 2D, the holder 50 comprises a plurality of rows 55 of wells 53, this is not essential. There may be at least one row 55 of wells 53.

The, or each, row 55 of wells 53 is sized so as to be receivable into the opening 20 of the base 10 across the opening width 21. However, the or each row 55 of wells 53 is sized so as to not be receivable into the opening 20 across the opening length 22. That is to say that the distance between the outermost surfaces of the first and last wells 53 in a row 55 is substantially equal to or less than the opening width 21 but larger than the opening length 22. Consequently, the holder 50 is receivable into the opening 20 in one orientation—with the rows 55 of wells 53 arranged in parallel with the opening width 21 and base width 17. Consequently, the holder 50 is not receivable in the opening 20 of the base 10 such that the rows 55 of wells 53 are arranged parallel to the opening length 22 or base length 18. Any attempt to try to insert the holder 50 into the opening 20 in such an orientation would cause at least one of the bottom ends of the wells 53 to impact a part of the top surface 11 of the base.

Advantageously, this signals to a user that they are attempting to insert a holder 50 into the base 10 in an orientation other than that intended. Advantageously, this arrangement therefore provides fool-proof assembly (poke-yoke)

With reference to FIG. 1A, it is to be noted that the base length 18 is larger than the base width 17 and that the opening length 22 is smaller than the opening width 21.

The holder 50 further comprises a skirt 52, as noted above. The skirt 52 extends substantially perpendicularly from the top surface 51 of the holder 50, as shown in FIGS. 2B and 2C. The skirt 52 extends in a direction substantially parallel to the longitudinal axis of the wells 53, as shown in FIG. 2C. The skirt 52 may extend substantially the same distance as the wells 53. In the embodiment shown in FIGS. 2A to 2D, the overall height of the wells 53 is slightly larger than the height of the skirt 52.

As shown in FIG. 2C, there is a gap 56 defined between the rear surface of the skirt 52 and the outer surface of the nearest row 55 of wells 53.

The skirt 52 is provided with at least one holder label 55. The holder label 55 may take a similar form to the base label 30, 31, e.g a visual label and/or an RFID tag. The holder label 55, or an associated database, may comprise various data related to the holder 50, including a unique identifier (e.g. serial number) for the holder 50, the type of holder 50, the dimensions of the holder 50, the number of wells, rows and/or columns, and/or details of the contents of the wells.

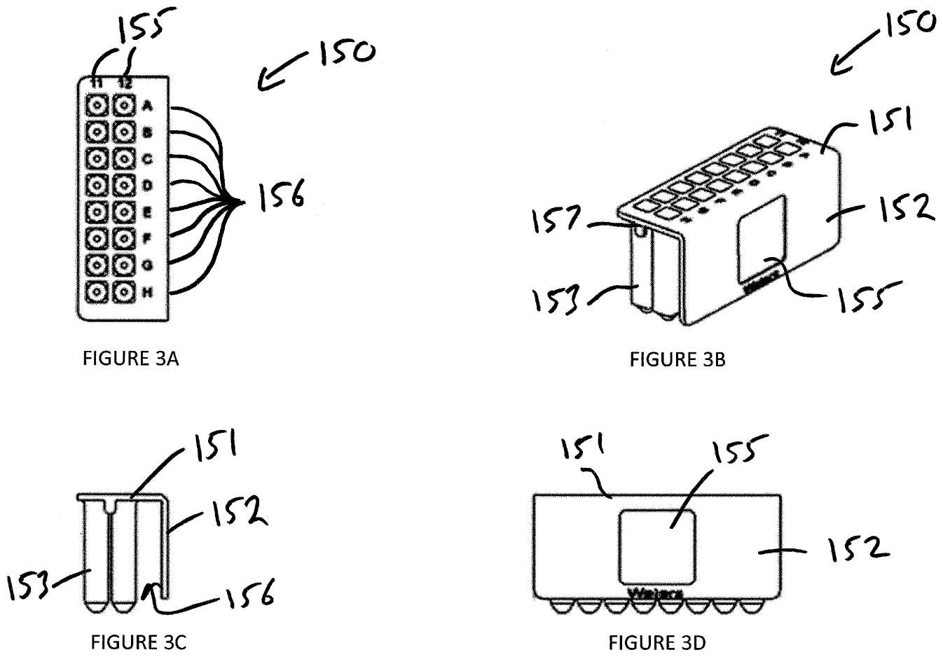

FIGS. 3A to 3D show another holder 150 of a vial carrier assembly 1 embodying the present invention. The holder 150 shown in FIGS. 3A to 3D is similar in many respects to the holder 50 shown in FIGS. 2A to 2D, but has fewer rows 155 of wells 153. Similar features are numbered correspondingly to those in FIGS. 2A to 2D, transposed by 100. In the embodiment shown, there are two rows 155 of wells 153, labelled 11 and 12 on the top surface 151 of the holder 150. The skirt 152 and the gap 156 are otherwise identical to the holder 50 shown in FIGS. 2A to 2D, as will be appreciated by the reader. It will further be appreciated that the holder 150 shown in FIGS. 3A to 3D could notionally be provided by taking a holder 50 as illustrated in FIGS. 2A to 2D and simply removing five of the rows 55 (numbered 6 to 10).

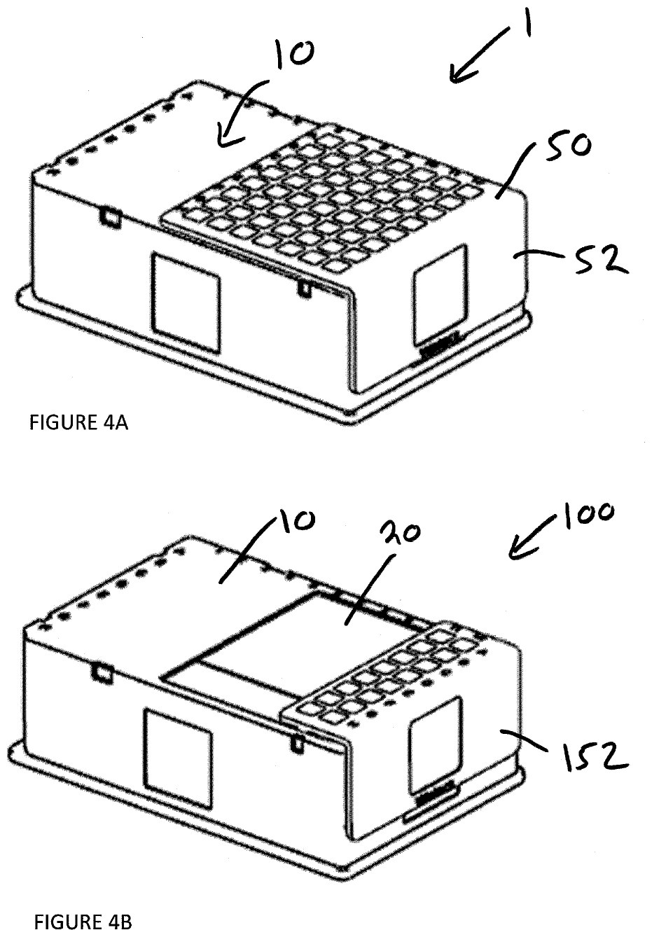

FIG. 4A illustrates the base 10 of FIGS. 1A to 1D and the holder 50 shown in FIGS. 2A to 2D. Likewise, FIG. 4B illustrates a vial carrier assembly 100 comprising the base 10 illustrated in FIGS. 1A to 1D and the holder 150 illustrated in FIGS. 3A to 3D

As shown in FIGS. 2B and 2C, the holder 50 comprises at least one locating feature 57, which is configured, in use, to be received in a corresponding locating feature 25 on the base 10.

Likewise, the holder 150, as shown in FIGS. 3B and 3C is provided with at least one locating feature 157, which is configured, in use, to be received in a corresponding locating feature 25 on the base 10.

When the locating features 57, 157, of the holder 50, 150, are correctly located in the corresponding locating features 25 on the base 10, this will indicate to a user that the holder 50, 150, and thus the wells 53, 153, are correctly located relative to the base 10. Consequently, to the extent that the base 10 is used to define a datum point for a liquid handler, the reliable and repeatable insertion of the holder 50, 150, into the opening 20 of the base 10 allows for the wells 53, 153, to be arranged at known co-ordinates relative to the datum point of the base 10.

As will be seen in FIG. 4A, and 4B, as the plurality of wells 53, 153, are received into the opening 20, across the opening width, the skirt 52 is arranged outside of the base 10, adjacent the front wall 12. The front wall 12 of the base 10, and the part of the top surface 11 between the front wall 12 and the adjacent edge of the opening 20, are received into the gap 56, 156, of the holder 50, 150. The rear surface of the skirt 52, 152, may be in contact with the front wall 12 of the base 10, or spaced therefrom.

In the embodiment shown, since the skirt 52, 152 of the holder 50, 150, is sized so as to be positioned outside of the base 10, the skirt 52, 152 is configured so as to at least partially conceal one of the base labels 30, 31 on the base 10. In the embodiment shown, it will be noted that the skirt 52, 152, almost entirely conceals the base label 31 on the front wall 12 of the base 10.

The asymmetric positioning of the opening 20 relative to the length of the base 10, and that the wells 53, 153 of the holder 50, 150 are receivable into the opening 20 across its width but not its length, means that the holder 50, 150 may only be received in the opening of the base 10 in a predetermined orientation and location.

The partial or total concealment of a base label by the skirt 52, 152 may advantageously be used to verify when a holder has been correctly inserted into a base.

Accordingly, another aspect of the present invention provides a vial carrier assembly handling system comprising:
a least one reader, configured to read at least one label on a base and/or holder of a vial carrier assembly arranged in readable range of the at least one reader;
a controller operatively connected to the at least one reader, the handling system configured to:
receive a command to verify the presence of a holder of the vial carrier assembly;
   read a label arranged in readable range of the at least one reader; and
   determine if the label is associated with a base or a holder, whereby:
if the label is associated with a base, return an error; and
if the label is associated with a holder, send a verification signal to indicate the presence of a holder.

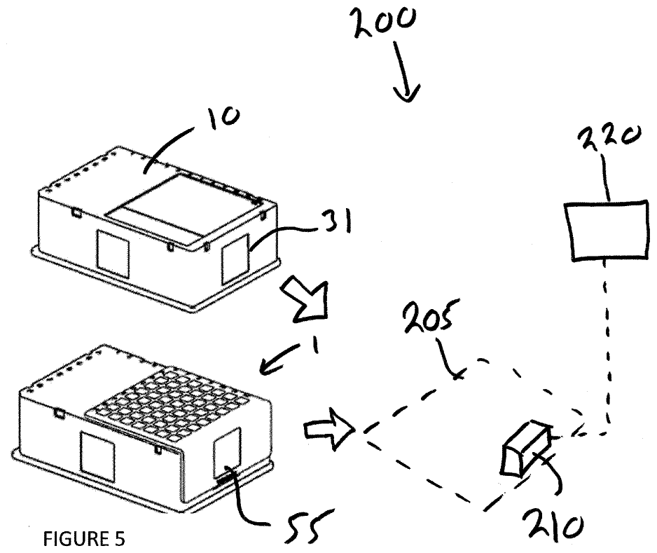

The vial carrier assembly handling system 200 is illustrated schematically in FIG. 5. The system 200 comprises at least one reader 210 and a controller 220. The system 200 may further comprise, or be position relative to, a receiving location 205 for a vial carrier assembly. The receiving location 205 may be part of a liquid handler, and comprise features and/or markings which ensure the correct placement of a vial carrier assembly in the receiving location 205 and thus relative to the reader 210.

The holder 50, 150 may be selectively retainable in or on the base 10. The holder 50, 150, may be retained on the base 10 by one or more of: magnetic force, a catch, a locking mechanism, and/or by an interference fit of the front wall 12 of the base 10 in the gap 56, 156.

The base 10 may be intended to be a reusable component, and the holder 50, 150 may be a consumable component.

In the embodiment shown in FIGS. 2A to 2D and 3A to 3D, the holder 50, 150, is a substantially unitary part. The holder 50, 150, may be substantially moulded from the same material, in a single process, and/or otherwise assembled in a way where it is not intended, in normal use, to be disassembled.

The holder 50, 150, may have a width of 82 cm. At least in the embodiment shown in FIGS. 2A to 2D and 3A to 3D, the width of the holder is effectively the width of the skirt 52, since it extends partially beyond the wells 53 at either end.

The width of the skirt 52 may at least be larger than the opening width, so as to prevent the user from incorrectly assembling the vial carrier.

As it will be appreciated from FIGS. 2B and 3B, the length of the holder 50, 150, will differ depending on the number of rows 55, 155, of wells 53, 153 provided. Nevertheless, the length of the holder may be between 30 cm and 77 cm.

Regardless of the number of rows 55, 155, it is preferred that the number of rows 55 is less than the number of columns 56 (or, put another way, the number of wells in each row). This asymmetry between the rows and columns allows for a holder to be received in the opening of the base in a predetermined location and/or orientation, as described above.

In another embodiment of the present invention, the holder may comprise at least two holder modules, each comprising at least one row of wells, and the at least two holder modules are arrangeable together to define the holder. Thus, one of the holder modules may be populated with vials and/or liquids at a location remote from another of the holder modules being populated with vials/liquid. Where the vials/liquids may have differing storage requirements, this advantageously allows for those storage and/or handling requirements to be met, with the holder modules only brought together to form a holder immediately before insertion of the holder into the base.

When used in this specification and claims, the terms “comprises” and “comprising” and variations thereof mean that the specified features, steps or integers are included. The terms are not to be interpreted to exclude the presence of other features, steps or components.

The invention may also broadly consist in the parts, elements, steps, examples and/or features referred to or indicated in the specification individually or collectively in any and all combinations of two or more said parts, elements, steps, examples and/or features. In particular, one or more features in any of the embodiments described herein may be combined with one or more features from any other embodiment(s) described herein.

Protection may be sought for any features disclosed in any one or more published documents referenced herein in combination with the present disclosure.

Although certain example embodiments of the invention have been described, the scope of the appended claims is not intended to be limited solely to these embodiments. The claims are to be construed literally, purposively, and/or to encompass equivalents.

1. A vial carrier assembly comprising:
a base having an opening, the opening having a width and a length, the base further comprising at least one base label; and
a holder comprising a least one row of wells, the at least one row of wells of the holder being sized so as to be receivable into the opening across the width of the opening but not receivable into the opening across the length of the opening, the holder further comprising a skirt, configured such that when the at least one row of wells is received in the opening, the skirt of the holder is positioned outside of the base, and the skirt is further configured to at least partially conceal the or a base label when the at least one row of wells is received in the opening.

2. A vial carrier assembly comprising:
a base having an opening, the base having a width and a length and the opening having a width and a length, the base further comprising at least one base label; and
a holder comprising a least one row of wells, the at least one row of wells of the holder being sized so as to be receivable into the opening across the width of the opening, wherein the length of the base is larger than the width of the base and the length of the opening is smaller than the width of the opening, the holder further comprising a skirt, configured such that when the at least one row of wells is received in the opening, the skirt of the holder is positioned outside of the base, and the skirt is further configured to at least partially conceal the or a base label when the at least one row of wells is received in the opening.

3. A vial carrier assembly comprising:
a base having an opening, the opening having a width and a length, the base further comprising at least one base label; and
a holder comprising a least one row of wells, the at least one row of wells of the holder being sized so as to be receivable into the opening across the width of the opening at a single predetermined location in a predetermined orientation, the holder further comprising a skirt, configured such that when the at least one row of wells is received in the opening, the skirt of the holder is positioned outside of the base, and the skirt is further configured to at least partially conceal the or a base label when the at least one row of wells is received in the opening.

4. A vial carrier assembly according to claim 1, wherein the holder comprises a plurality of rows of wells arranged parallel to one another to form an array of wells.

5. A vial carrier assembly according to claim 4, wherein the number of rows of wells is less than the number of wells in each row.

6. A vial carrier assembly according to claim 1, wherein the base comprises a top surface and the opening is provided on the top surface.

7. A vial carrier assembly according to claim 6, wherein the opening is asymmetrically positioned on the top surface.

8. A vial carrier assembly according to claim 6, wherein the base comprises a front wall, a back wall and two side walls.

9. A vial carrier assembly according to claim 8, wherein the opening is positioned closer to the front wall than to the back wall.

10. A vial carrier assembly according to claim 9, wherein the opening is positioned substantially equidistantly from the two side walls.

11. (canceled)

12. A vial carrier assembly according to claim 1, wherein the skirt extends from the holder in a direction substantially parallel to the axes of the wells.

13. (canceled)

14. A vial carrier assembly according to claim 1, wherein the opening is provided with at least one locating feature, and the holder is provided with at least one complementary locating feature.

15. A vial carrier assembly according to claim 1, wherein the holder is selectively retainable in or on the base.

16. A vial carrier assembly according to claim 1, wherein the holder comprises at least two holder modules, each comprising at least one row of wells, the at least two holder modules being arrangeable together to define the holder.

17. A vial carrier assembly according to claim 1, wherein the base has a width of 85.5 cm and a length of 127.8 cm.

18. A vial carrier assembly according to claim 1, wherein the holder has a width of 82 cm.

19. A vial carrier assembly according to claim 18, wherein the holder has a length between 30 cm and 77 cm.

20. (canceled)
